(19) United States
(12) Patent Application Publication
(10) Pub. No.: US 2025/0072434 A1
(43) Pub. Date: Mar. 6, 2025

(54) COMPOSITIONS AND METHODS FOR REDUCED LEAVENING TIME AND SODIUM CONTENT IN DOUGHS COMPRISING MICRON-SIZED SALT PARTICLES ADHERED TO A CARRIER

(71) Applicant: MICROSALT PLC, London (GB)

(72) Inventors: Richard Guiney, Lake Worth, FL (US); Clifford Gross, Miami, FL (US)

(73) Assignee: MICROSALT PLC, London, EN (GB)

(21) Appl. No.: 18/825,936

(22) Filed: Sep. 5, 2024

Related U.S. Application Data
(60) Provisional application No. 63/580,590, filed on Sep. 5, 2023.

(51) Int. Cl. A21D 13/06; A21D 8/04

(52) U.S. Cl. CPC A21D 13/06; A21D 8/047

(57) ABSTRACT

Doughs for baked goods produced with low sodium salt compositions comprising salt particles adhered to a bulk carrier in specified proportions and methods of producing same of the present invention are improved over prior alternative doughs by having less sodium content per serving and a reduced proofing, leavening and/or overall bake time when compared to doughs prepared with traditional salt.

### CROSS-REFERENCE TO RELATED APPLICATIONS

This application is a nonprovisional application claiming priority to U.S. Provisional Patent Application No. 63/580,590 filed on Sep. 5, 2023 and entitled COMPOSITIONS AND METHODS FOR REDUCED LEAVENING TIME AND SODIUM CONTENT IN DOUGHS COMPRISING MICRON-SIZED SALT PARTICLES ADHERED TO A CARRIER, which is hereby incorporated by reference in its entirety.

### TECHNICAL FIELD

Various embodiments relate generally to food products and methods of producing same.

### BACKGROUND

Bread is a staple food item in many cultures around the world. However, the baking process can be time-consuming, and the sodium content of bread produced according to traditional recipes and manufacturing processes can account for a significant portion of a healthy individual's recommended daily maximum consumption of sodium (2300 milligrams (mg), as per the World Health Organization).

According to the authors of Top Sodium Food Sources in the American Diet Using National Health and Nutrition Examination Survey¹, Mavra Ahmed, Alena (Praneet) Ng, Anthea Christoforou, Christine Mulligan, and Mary R. L'Abbé, “Reducing population-level sodium intake can reduce hypertension, an important preventative strategy to lower the risk of cardiovascular diseases, the leading cause of death in the United States. Considering that most dietary sodium is derived from prepackaged foods, this study quantitatively estimates the proportion contribution and mean sodium intake from key food category contributors to total sodium intake in the US population. Data from the 2017-2018 National Health and Nutrition Examination Survey, which collected interviewer-administered 24 h dietary recalls from Americans (n=7081), were analyzed.” From this analysis the authors found that breads, rolls, and buns accounted for approximately 4.7% of daily sodium consumption and cookies, brownies and cakes accounted for an additional 2.4% of daily sodium consumption. ¹ AHMED M., NG A. P., CHRISTOFOROU A., MULLIGAN C., L'ABBÉ M. R., Top Sodium Food Sources in the American Diet-Using National Health and Nutrition Examination Survey, webpage, 2023 Feb. 6 (https://www.ncbi.nlm.nih.gov/pmc/articles/PMC9932803/)

According to the World Health Organization, cardiovascular diseases are the leading cause of death globally, with approximately 17.9 million people dying from cardiovascular diseases in 2019, representing 32% of all global deaths. Of these deaths, 85% were due to heart attack and stroke.² According to the Centers for Disease Control, “About 610,000 people die of heart disease in the United States every year—that's 1 in every 4 deaths.” In the U.K., there are about 160,000 deaths from heart disease each year accounting for 26% of all deaths. ²WORLD HEALTH ORGANIZATION (WHO), Cardiovascular Diseases (CVDs), 2021 Jun. 11 (https://www.who.int/news-room/fact-sheets/detail/cardiovascular-diseaases-(cvds))

According to Yi-Jie Wang et al³, every gram (1 g) of dietary sodium intake increases the risk of cardiovascular disease by 6%. ³WANG YJ, YEH TL, SHIH MC, TU YK, CHIEN KL, Dietary Sodium Intake and Risk of Cardiovascular Disease: A Systematic Review and Dose-Response Meta-Analysis, webpage, 2020 Sep. 25 (https://www.ncbi.nlm.nih.gov/pmc/articles/PMC7601012/#:˜:text=The%20risk%20of%of%20CVD%20with.risk%20of %20CVD%20bv%206%25)

U.S. Pat. No. 8,900,650 describes a salt composition including a carrier particle having disposed thereon a plurality of salt crystallites. The methods include providing an aqueous slurry comprising an aqueous solvent and a selected percent by weight of a solids mixture, wherein the solids mixture comprises salt and a carrier medium, and wherein the carrier medium is present in an amount between about 25% by weight and about 75% by weight of the aqueous solvent; and exposing the slurry to a drying process to both: a) form a carrier particle comprised of the carrier medium; and b) form a plurality of salt particles of an average size of less than about 20 microns on the surface of the carrier particle, with the salt particles on the surface of the carrier particle having an average size ranging from 100 nanometers to less than 2 microns.

The salt-carrier product described in U.S. Pat. No. 8,900,650 can be a bulking agent, carbohydrate or its derivative, starch, maltodextrin, hydrocolloid, protein, protein derivative, starch, pre-gelatinized starch, modified starch, pyrodextrin, gum, cereal flour, or tuber flour yeast extract, flavor enhancer, or lipid. The drying process can include freeze drying, spray drying, spray cooking, or roll drying process.

U.S. Pat. No. 11,992,034 describes an improved low-sodium salt composition, where the salt-particles adhered to the carrier are of an average size of less than 2 microns to less than 100 nanometers and the resultant salt-carrier particles coat and adhere better to foods than salt that is not adhered to a carrier particle.

The present invention describes compositions and methods for incorporating low-sodium salt compositions in foods such as bread doughs and the like, to produce low sodium baked goods requiring a decreased leavening time leading to a faster and greener (e.g., environment-friendly) production process with reduced energy expenditure.

### SUMMARY

Compositions and associated methods relate to food products comprising lower sodium content than traditional table salt when a low sodium salt composition or product (e.g., a combination of salt and carrier product) is used in the same amount or less as traditional table salt in baked goods. The low sodium salt composition may be comprised of one to a plurality of micron-sized salt particles adhered to a carrier particle, for example, maltodextrin. In an illustrative example, employing a method of using micron sized salt-carrier particles in a dough-making process may reduce the leavening time and sodium content in breads and other baked goods traditionally comprising salt as an ingredient.

It is an object of the present invention to provide a composition and method for reducing the leavening time for doughs, e.g., doughs for making breads, buns, pastries, pizzas, bagels, doughnuts, etc.

It as an object of the present invention to provide a composition and method having a commercial economic and environmental benefit, for example, as a result of reduced leavening time of a dough reducing the process and/or production time of doughs and baked goods, making production processes more efficient than traditional production processes.

It is an object of the present invention to provide a composition and method providing a health benefit of less sodium content in foods.

It is an object of the present invention to provide a composition and method for preparing baked goods with an improved nutritional profile.

It is another object of the present invention to improve the sodium profile of baked goods, including breads, pastries, and cakes. In some embodiments, the baked goods may be bagels, pitas, leavened confectionary snacks, and/or extruded leavened flavored snacks.

It is an object of the present invention to provide a method for producing dough involving the incorporation of a low sodium salt composition comprising micron-sized salt particles adhered to a carrier particle into the dough, wherein the small size of the low sodium salt composition particles disperse more evenly across the dough as compared to traditional salt.

It is an object of the present invention to provide a method for producing dough incorporating a low sodium salt composition wherein leavening agents such as yeast in the dough are activated more effectively than when traditional salt is incorporated in the dough.

It is another object of the present invention to provide a method for producing dough incorporating a low sodium salt composition, wherein the proof time of the dough (at any proofing stage) is reduced anywhere from 15-50%, for example, 25% or 36%, when compared to doughs incorporating traditional salts.

It is another object of the present invention to provide a method for producing dough incorporating a low sodium salt composition wherein the effort required by a user to prepare baked goods is reduced.

It is an object of the present invention to provide a composition and method for having a low sodium salt composition comprising one to a plurality of salt particles adhered to a carrier and having a powder-like form and/or texture which may accelerate the dissolution rate and distribution of the salt in the dough.

It is an object of the present invention to provide a composition and method for having a low sodium salt composition and dough composition that lowers sodium content and enhances the leavening process, leading to faster production cycles.

In some embodiments, a low sodium salt composition may be formed by a process comprising: providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle.

In some embodiments, a low sodium salt composition may be formed by a process comprising: providing an aqueous salt-carrier slurry comprising an aqueous solvent and a selected percent by weight of a solids mixture, wherein the solids mixture comprises a salt present in an amount between about 2.5% by weight and less than 14.9% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle.

It is another object of the present invention to provide a method for producing dough which incorporates a low sodium salt composition, which, when applied to a dough recipe or mixture at the beginning of the dough making process (as opposed to the end) may result in faster proof time (e.g., reduced proof time when compared to traditional bread-making processes) and/or reducing the amount of leavening agent (e.g., yeast) required to achieve a particular proof level. Such a method of bread production may be contrary to conventional bread-making processes as salt is typically added after leavening agents such as yeast have been activated.

The details of various embodiments are set forth in the accompanying drawings and the description below. Other features and advantages will be apparent from the description and drawings, and from the claims.

### BRIEF DESCRIPTION OF THE DRAWINGS

FIG. 1 is a schematic flow diagram depicting the process for making the improved salt-carrier product described herein.

### DETAILED DESCRIPTION OF ILLUSTRATIVE EMBODIMENTS

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

In general, reducing sodium content in doughs for breads and other baked goods offers several benefits, ranging from health improvements to potential changes in flavor and texture. For example, lower sodium intake can reduce the risk of heart disease and stroke by minimizing the adverse effects on the heart and circulatory system. Moreover, reducing sodium helps lower blood pressure, which is crucial for preventing hypertension and related cardiovascular diseases. High sodium intake is linked to increased blood pressure, which can strain the heart and blood vessels.

In some scenarios, excessive sodium can strain the kidneys, which are responsible for regulating sodium balance and blood pressure. Reducing sodium can alleviate this strain and improve overall kidney function.

As used herein, the phrases “nanometer- to micron-sized” or “nanometer- to micron-scale” and similar phrases carry their ordinary meaning, that is, they refer to objects having at least one dimension of nanometer or micron scale.

As used herein, the phrases “nanometer- to micron-sized” or “nanometer- to micron-scale” and similar phrases carry their ordinary meaning, that is, they refer to objects having at least one dimension of nanometer or micron scale. “Salt particles” can refer to a specific size, e.g., a narrow size distribution of particles, or a collection of particles of different sizes, e.g., a mean size for a population of salt particles.

As it related to the disclosure herein, low sodium salts used in dough compositions may comprise nanometer- to micron-sized salt particles adhered to a carrier to deliver the ultra-small salt particles to a consumer's mouth. The term “adhered” as used herein carries its ordinary meaning: to be joined or united, or attached. The processes involved in adhering salt particles to carriers may include chemical ionic and covalent bonding, surface tension, adhesion, and any other physical process that joins the two entities.

“Salt” can be any type of salt, e.g., sodium chloride, potassium chloride or a combination thereof. In certain preferred embodiments, “salt” refers to salts of sodium, chloride, potassium or sulfate ions.

“Leavening agent(s)” can be any type of leavening agent(s), e.g., yeast, sourdough starter, baking powder, baking soda (sodium bicarbonate), ammonium bicarbonate (Baker's Ammonia), or potassium bicarbonate, or any combination therein, or any other leavening agent(s) known in the art.

Carriers can include, without limitation, bulking agents, cereal and tuber starches, maltodextrins, cereal and tuber flours, hydrocolloids, proteins, protein powders, including those from any plant or animal source, including, but not limited to cereals, tuber, dairy and whey powders; flavors, and seasonings, among others. Proteins can be any protein source from plant or animal, including dairy, meat, corn, etc. Carriers can vary in size and shape and can be processed from their original form (e.g., protein powders can be further refined or milled to a desired size) to provide a desired functionality, such as bulk flow or bulk density. In some embodiments, utilizing a carrier to deliver salt particles can provide certain packing, storage, and use benefits. For example, a carrier can be chosen to provide a desired bulk density for a particular salt-carrier product. In another example, a carrier may be chosen for its bulk flow characteristics in large-scale foods processing, or for its hydrophobic or hygroscopic properties. Maltodextrin has been determined to be a preferred carrier. References herein to “salt-carrier products”, “low sodium salts” or “low sodium salt compositions” refer to nanometer- or micron-scale salt particles adhered to a carrier.

In general, salt particles can be adhered to the surface of a carrier. The degree of salt coverage on the particle can be varied to produce various taste effects, including adjusting the intensity of a salty flavor. In addition, the bulk density of the salt, e.g., sodium chloride, in a salt-carrier product can be adjusted by controlling the salt coverage on the particle.

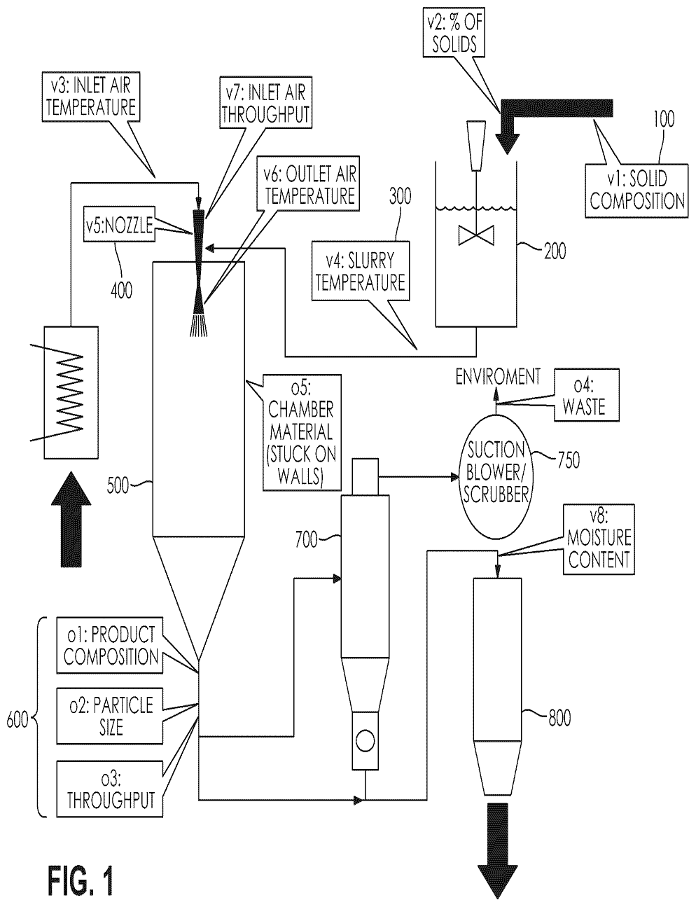

FIG. 1 is a schematic flow diagram of an exemplary process for making the improved salt-carrier product. A salt-carrier product can be made, according to one of many methods, by carrying out the following steps, which need not necessarily be performed in the order presented.

At step 100, a solid composition of salt and a carrier is prepared to create a salt-carrier slurry by adding a selected carrier, preferably maltodextrin, to water in a tank with good agitation and heating the tank to a temperature of 176° F.±10° F. to dissolve the carrier and then add the salt to the tank and continuing to heat the aqueous salt-carrier solution at a temperature of 176° F.±10° F. and agitating it for sufficient time to ensure the salt is dissolved and it becomes an aqueous salt-carrier slurry at step 300. Alternatively, the salt and carrier could be combined with the water and heated at different temperatures for different times, so long as the salt, carrier, and water are substantially dissolved to become an aqueous salt-carrier slurry.

The concentration of salt in the salt solution can be adjusted to provide a desired coverage of salt on the resulting salt-carrier product. The salt can include single salts (e.g., sodium chloride) or a mixture of salts (e.g., sodium chloride, potassium chloride, ammonium chloride, etc.). The carrier can be any bulking agent, e.g., a powdered bulking agent, including but not limited to proteins, carbohydrates or their derivative(s), (maltodextrin, pre-gelatinized starch, gums, cereal flours and the like) and also including carbohydrates made up of small glucose molecules (e.g., tapioca), hydrocolloids, hydrolyzed proteins, yeast extracts, and flavorings. In some embodiments, a combination of different types of carriers can be used, e.g., a combination of a carbohydrate, a starch, and potassium salt can be used. The proportion of carrier to salt can be chosen to obtain a desired working density or other characteristic of the salt-carrier product. The salt-carrier mixture can then be mixed until homogeneous.

Examples of solid compositions used to create the salt-carrier slurry of the improved salt-carrier product include a salt plus carrier percent by weight of 11% to 39.9% aqueous solvent (water); a salt percentage by weight of aqueous solvent (water) of 3.9% to less than 25%; a carrier percentage of 2.77% to 24.9% by weight aqueous solvent (water); a salt plus carrier percentage by weight of aqueous salt-carrier slurry of 10 to 39.9%; a salt percentage by weight of aqueous salt-carrier slurry of 2.5% to 14.9%.

In an illustrative example, the percent solids in the slurry may be 25%, the percent of salt in the solids composition may be 70%, and the percentage of salt in the solution may be 17.5%. In such an example, the percent of carrier in the solids composition may be 30% and the percentage of carrier in the solution may be 7.5%.

In another illustrative example, the percent solids in the slurry may be 25%, the percent of salt in the solids composition may be 80%, and the percentage of salt in the solution may be 20%. In such an example, the percent of carrier in the solids composition may be 20% and the percentage of carrier in the solution may be 5%.

In another illustrative example, the percent solids in the slurry may be 25%, the percent of salt in the solids composition may be 60%, and the percentage of salt in the solution may be 15%. In such an example, the percent of carrier in the solids composition may be 40% and the percentage of carrier in the solution may be 10%.

In another illustrative example, the percent solids in the slurry may be 25%, the percent of salt in the solids composition may be 48%, and the percentage of salt in the solution may be 12%. In such an example, the percent of carrier in the solids composition may be 52% and the percentage of carrier in the solution may be 13%.

In another illustrative example, the percent solids in the slurry may be 20%, the percent of salt in the solids composition may be 70%, and the percentage of salt in the solution may be 14%. In such an example, the percent of carrier in the solids composition may be 30% and the percentage of carrier in the solution may be 6%.

In another illustrative example, the percent solids in the slurry may be 20%, the percent of salt in the solids composition may be 60%, and the percentage of salt in the solution may be 12%. In such an example, the percent of carrier in the solids composition may be 40% and the percentage of carrier in the solution may be 8%.

In another illustrative example, the percent solids in the slurry may be 20%, the percent of salt in the solids composition may be 50%, and the percentage of salt in the solution may be 10%. In such an example, the percent of carrier in the solids composition may be 50% and the percentage of carrier in the solution may be 10%.

In another illustrative example, the percent solids in the slurry may be 15%, the percent of salt in the solids composition may be 70%, and the percentage of salt in the solution may be 10.5%. In such an example, the percent of carrier in the solids composition may be 30% and the percentage of carrier in the solution may be 4.5%.

In another illustrative example, the percent solids in the slurry may be 15%, the percent of salt in the solids composition may be 60%, and the percentage of salt in the solution may be 9%. In such an example, the percent of carrier in the solids composition may be 40% and the percentage of carrier in the solution may be 5%.

In another illustrative example, the percent solids in the slurry may be 15%, the percent of salt in the solids composition may be 50%, and the percentage of salt in the solution may be 7.5%. In such an example, the percent of carrier in the solids composition may be 50% and the percentage of carrier in the solution may be 7.5%.

In another illustrative example, the percent solids in the slurry may be 36%, the percent of salt in the solids composition may be 60%, and the percentage of salt in the solution may be 21.6%. In such an example, the percent of carrier in the solids composition may be 40% and the percentage of carrier in the solution may be 14.4%.

In some embodiments, the aqueous slurry may comprise the salt plus the carrier in an amount of about 10% to 36% by weight of the aqueous salt-carrier slurry and salt in an amount about 2.5% to less than 25% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%. For example, the percent solids in the slurry may be 36%, 25%, 20%, 15%. In an illustrative example, when the percent solids in the slurry is 15%, the percent of water content in the slurry is 85%.

At step 400, an aqueous salt-carrier slurry is fed into a nozzle of a drying chamber that has several orifices to spray out the slurry at different angles and drop sizes that can affect particle sizes into a drying chamber at step 500 with particle sizes inversely proportional to the angle aperture and directly proportional to the orifice aperture. The inlet temperature of the drying chamber is preferably 360° F.±25° F. Changing the amount of slurry that is pumped through the nozzle at step 400 can control the moisture content to 1.2% to 5%. Moisture content is the water content of the resulting product. The amount of slurry pumped through the nozzle into the drying chamber is controlled through the pump and compressor while slowed by the nozzle resistance (pressure drop).

The slurry should remain in the drying chamber until desired moisture content is reached and either precipitates to the collection hopper or is pulled by the cyclone as per regular Spray Drying practices, when they exit the outlet of the drying chamber at a temperature of 200° F.±25° F., followed by a cyclone at step 700 that collects the smaller particles that are too light to gravitate on the drying chambers hopper, a step particularly important as particle sizes of this process generates more smaller particles than typical spray drying processes. There is a suction blower/scrubber process at step 750 and a bagger process at step 800 that bags the resulting salt-carrier particles.

The salt-carrier mixture can then be subjected to a process to drive off (evaporate) water. In general, it can be advantageous to drive off water quickly, so as to reduce the growth time of salt nuclei that form on the surface of the carrier during the drying process. Exemplary processes for removing water from the carrier-slurry mixture include spray drying, spray cooking, freeze drying, and drum drying, among others.

In one approach, the average size of the salt particles can be controlled by adjusting parameters during the drying process, e.g., a spray-drying process, including one or more of (not by way of limitation): the ratio of salt-to-carrier in the slurry as described in the examples above, and spray drying parameters, including one or more of the inlet temperature, pump speed, air flow, and compressor pressure. It will be understood that various other means can be used to achieve similar results. Drying temperatures and times may vary particularly when methods other than spray drying are used in the drying process.

The improved process may produce salt particles of an average size of 100 nanometers to less than 50 microns adhered to or on the surface of the carrier. In some examples, the improved process may produce salt particles of an average size of less than 30 microns adhered to or on the surface of the carrier.

The present invention seeks to provide a method of reducing the leavening time and sodium content in doughs or batters for baked goods, for example, breads, cakes, pastries, and cookies. This may provide a combined economic and health benefit for the preparation of baked goods with an improved nutritional profile. The method may generally comprise the following steps: (1) preparing a low sodium salt composition comprising micron-sized salt particles adhered to a carrier (e.g., maltodextrin); (2) applying the low sodium salt composition and flour at a ratio of one teaspoon of the low sodium salt composition per cup of flour to a mixture of leavening agent (e.g., yeast), water, and/or sugar; and (3) baking the dough or batter in an oven.

In accordance with embodiments of the present invention, a method of reducing the leavening time and sodium content in a baked good may comprise the steps of: (1) adding a salt-carrier composition comprising a plurality of micron-sized salt particles adhered to one or more carrier particles to a batter comprising flour, at least one leavening agent (e.g., yeast) and water; and (2) baking the batter to form a baked good. In some embodiments, the plurality of salt particles adhered to the carrier particle may be of an average size of less than 100 nanometers. In some examples, the plurality of salt-particles may be of an average size of less than 30-50 microns. Still in other examples, the plurality of salt-particles may be of an average size of less than 30 microns. In some embodiments, the salt-carrier composition may comprise between 15-60% of the carrier particles by weight of the salt-carrier composition and 40-85% of the salt particles by weight of the salt-carrier composition.

In accordance with embodiments of the present invention, a low sodium dough composition may comprise: flour, at least one leavening agent (e.g., yeast), water, and low sodium salt composition (e.g., at a ratio of one teaspoon of low sodium salt composition per cup of flour), the low sodium salt composition comprising a plurality of salt-particles of an average size of less than 50 microns to less than 30 microns adhered on a surface of one or more carrier particles. In some embodiments, the plurality of salt-particles may be of an average size of less than 30 microns. In some embodiments, the salt-carrier composition may comprise between 15-60% of the carrier particles by weight of the salt-carrier composition and 40-85% of the salt particles by weight of the salt-carrier composition.

In accordance with embodiments of the present invention, micron-sized salt particles may have a particle size that is approximately 1000× smaller than traditional salt (e.g., traditional table salt) (or 100× smaller than milled salt). Using micron sized salt in a dough composition may help to reduce the sodium content of a baked good, e.g., bread, by increasing the dissolution rate of the salt on sodium receptors on the tongue, thereby requiring less salt whilst producing an equivalent sensory profile. Moreover, as discussed in more detail below, micron-sized salt particles may help to more efficiently and/or effectively break down gluten found in dough which may result in a faster rise time.

Without wishing to be bound to theory, Applicants believe that the low sodium salt compositions disclosed herein, which, in accordance with the disclosure herein, may comprise micron-sized salt-particles adhered to a carrier, may help align the gluten strands in kneaded dough to help the gluten strands stick together, causing the dough and/or bread structure to be more cohesive. Gluten is a protein that gives baked goods, e.g., breads and the like, their structure and elasticity. When gluten in doughs are broken down, doughs become more pliable and easier to work with. In some scenarios, this enables carbon dioxide gas bubbles within the dough to expand more easily and stay in the bread (since the gluten strands are what holds the carbon dioxide within dough and/or bread), which may result in faster rise or leavening time.

Salts may also function as enzymes and act as yeast inhibitors, so reducing salt content should be balanced between the gluten strands formation described above and yeast inhibition. If the same flavor can be achieved with lower salt and the gluten strands are being formed, the lower salt content may inhibit yeast activation less than would otherwise be the case with traditional table salt. This improved process may work to speed the yeast fermentation process and, as such, may speed dough proofing (leavening) time as well.

In accordance with embodiments of the present invention, a low sodium salt composition may comprise one to a plurality of micron-sized salt particles adhered to a carrier. In a preferred embodiment, the carrier is maltodextrin. Maltodextrin is a type of carbohydrate that is made up of small glucose molecules. Maltodextrin may be a good source of energy for yeast, and may help to speed up the yeast fermentation process. When yeast ferments, it produces carbon dioxide gas, making dough or batter rise and become light and porous. The addition of maltodextrin to dough may provide yeast with more energy to produce carbon dioxide gas, which may result in a faster rise time. Maltodextrin also has a lower temperature at which the Maillard Reaction (a chemical reaction between amino acids and reducing sugars that gives browned food its distinctive flavor) starts applying and help the browning process (e.g., toasting) of breads and other baked goods start sooner.

In accordance with embodiments of the present invention, in addition to reducing the leavening time, using micron-sized salt particles adhered to maltodextrin to produce doughs can also improve the texture and flavor of any resultant baked good, including bread. The salt particles may help to prevent the formation of large air bubbles in the dough, which may result in a more uniform crumb structure. Maltodextrin also helps to retain moisture in dough, which results in a moist and more flavorful bread. Moreover, maltodextrin may improve the overall time it takes to generate a toasted appearance of bread. Maltodextrin incorporated into the disclosed low sodium salt has a lower “toast point” (e.g., time and/or temperature needed to give breach a toasted appearance, taste, and/or feel) as compared to traditional salt and may allow for a reduction of in-store production time of a finished sandwich. In some scenarios, e.g., in commercial production and other applications, even a small degree of improvement (less than one second) is significant given the importance of sandwich production at a store (e.g., retail and/or commercial) level.

The mechanism for reducing leavening time with bread using salt-carrier particles comprising micron-sized salt particles adhered to a carrier (e.g., maltodextrin) may be summarized as follows: (1) micron-sized salt particles may be able to align the gluten strands in kneaded dough to help the gluten strands stick together, causing the dough and/or bread structure to be more cohesive; (2) when gluten is broken down, the dough becomes more pliable and easier for carbon dioxide gas bubbles within the dough to expand; (2) a particular carrier molecule to which the micron-sized salt particles adhere to may have its own particular benefit, for example, one of the benefits of a maltodextrin carrier is that it is a good source of energy for yeast, which may have a role in speeding up the fermentation process; (3) a faster dough rise time, a more uniform crumb structure, and a moister and more flavorful bread or other baked good; and/or (4) a reduction in the sodium content in food preparations by approximately 50% due to rapid dissolution rates when the foods come in contact with the salt taste sensors on the tongue.

Doughs produced in accordance with the compositions and methods of the present disclosure may have some or all of the following advantages: reduced leavening time, reduced sodium content, and improved texture and flavor. Specifically, for example, salt-carrier particles comprising micron-sized salt particles adhered to a carrier may be configured to dissolve more quickly than traditional salt, in effect, reducing the leavening time. This can be a significant advantage for bakers who are looking to reduce the production time of their bread. Moreover, for example, because salt-carrier particles comprising micron-sized salt particles adhered to a carrier may dissolve more quickly than traditional salt, a smaller quantity salt-carrier particles may be needed to match a traditional salty taste or profile. This may help to reduce the sodium content of the bread and may be a valuable benefit for consumers who are looking to reduce their sodium intake. Additionally, for example, salt-carrier particles comprising micron-sized salt particles adhered to a carrier (e.g., maltodextrin), may improve the texture and flavor of the resultant baked goods (e.g., bread). This can make the resultant bread more appealing to consumers.

In some scenarios, sodium can affect the texture of dough by influencing gluten formation. Reducing sodium content in doughs may lead to changes in texture, potentially allowing for different adjustments to achieve desired consistency.

The following are illustrative examples of the present invention:

### Example 1

In accordance with an example of the present invention, micron-sized salt particles may be mixed with a carrier particle, e.g., maltodextrin, to form a low sodium salt composition. The low sodium salt composition may be combined with the remaining ingredients for cooking dough, for example, flour, yeast, water, and oil, utilizing the following ratio: one teaspoon of the low sodium salt per cup of flour. The dough (e.g., bread dough) may be baked in accordance with bread baking specifications which may be provided in a recipe or product packaging (e.g., flour packaging), for example, baked in the oven at a temperature between 350° F. and 475° F. for any time between twenty and forty minutes. In accordance with embodiments of the present invention, due to the substitution of the salt-carrier particles produced in accordance with the processes described herein for traditional salt (e.g., standard table salt), the bread may be baked for 10-25% less time than the time specified in a given recipe or specifications on a given package (e.g., flour or dough packaging). Bread produced in accordance with this or a similar process may have a good texture and flavor, for example, that identical to, substantially the same as, or similar to bread produced of a dough recipe comprising traditional salt (e.g., standard table salt). In some scenarios, bread produced in accordance with the aforementioned process may have an improved texture and flavor of the bread.

### Example 2

In accordance with an example of the present invention, micron-sized salt particles may be mixed with a carrier particle, e.g., maltodextrin to form a low sodium salt composition. The low sodium salt composition may be combined with the remaining ingredients for cooking dough, for example, flour, at least one leavening agent (e.g., yeast), water, and oil, utilizing the following ratio: one teaspoon of the low sodium salt composition per cup of flour. The dough (e.g., bread dough) may be baked in accordance with bread baking specifications. In accordance with embodiments of the present invention, due to the substitution of the salt-carrier particles produced in accordance with the processes described herein for traditional salt (e.g., standard table salt), the bread may be baked for 10 to 25% less time than the time specified on a comparable baking recipe comprising traditional salt as an ingredient. Bread produced in accordance with this or a similar process may have a good texture and flavor, for example, that identical to, substantially the same as, similar to, or better than, bread produced of a dough recipe comprising traditional salt (e.g., standard table salt). In some scenarios, bread produced in accordance with the aforementioned process may have an improved texture and flavor of the bread.

The following table compares the proof (e.g., leavening) and cook time between a bread dough formulation comprising traditional table salt as compared to a bread dough formulation comprising the low sodium low sodium salt of the present invention.

| | |
|---|---|
| Traditional | Low sodium salt of |
| Table Salt | the present invention |

| | | | | |
|---|---|---|---|---|
| Mass | 10 | g | 8 | g |
| Dough weight after | 1767 | g | 1741 | g |
| proofing | | | | |
| Individual rolls | 104 | g | 104 | g |
| weight pre-cooking | | | | |
| (approximate) | | | | |
| Roll weight post | 96 | g | 104 | g |
| cooking | | | | |
| (approximate) | | | | |

| | | |
|---|---|---|
| Cooking time | 20 mins (2 trays) | 20 mins (2 trays) |

| | | | | |
|---|---|---|---|---|
| Proof time 1^{st} stage | 1 | hour | 45 | mins |
| Proof time 2^{nd} stage | 30 | mins | 19 | mins |

The first notable difference being the first stage proof time, with traditional table salt bread dough having a total first stage proof time of one hour, whereas low sodium low sodium salt bread dough of the present disclosure has a total first stage proof time of forty-five minutes. The second notable difference being the second stage proof time, with traditional table salt bread dough having a total second stage proof time of thirty minutes, whereas low sodium low sodium salt bread dough of the present disclosure has a total second stage proof time of nineteen minutes. A noticeable difference in proof times is observed at both proofing stages.

In some embodiments, with the improved low sodium salt, the leavening time during a first proofing stage may be reduced by at least 15 minutes compared to dough prepared with conventional salt. This reduction represents an at least 25% decrease in the proofing time from an initial 60 minutes to 45 minutes.

In some embodiments, during a second proofing stage, the use of the improved low sodium salt may decrease the leavening time of dough by at least 11 minutes to achieve an at least 36% reduction in the proofing time from an initial 37 minutes to 26 minutes.

In accordance with embodiments of the present invention, a reduction in proofing times may translate into faster production cycles, which may enhance overall manufacturing efficiency.

In accordance with embodiments of the present invention, shorter proofing times may contribute to lower energy consumption, as the dough may require less time in proofing equipment.

Although there are exceptions, baking times for the majority of traditionally baked breads (e.g., breads baked with traditional table salt) usually fall within the following ranges⁴: ⁴ Bread Baking Guide, recipetips.com, webpage, https://www.recipetips.com/kitchen-tips/t--1100/bread-baking: guide.asp

| Bread Type | Baking Time Ranges |
|---|---|
| Hearth breads, large country-style | 35 to 50 minutes |
| rounds, and breads baked on flat | |
| surfaces | |
| Basic breads baked in load pans and | 45 to 60 minutes |
| other containers | |
| Thin flat breads | 5 to 15 minutes |
| Thicker flat breads | 15 to 25 minutes |
| Quick breads | 45 to 75 minutes |
| Rolls and buns | 15 to 20 minutes |

Some other common bake time ranges for baked breads and other baked goods are provided in the table below⁵: ⁵ What Temperature Should I Bake Bread At?Times and Temps For Common Bread Types, kneadrisebake.com, webpage, https://kneadrisebake.com/what-temperature-should-i-bake-bread-at-times-and-temps-for-17-commun-bread-type/

| | | | Most Common | | |
|---|---|---|---|---|---|
| | Lowest Temp | Highest Temp | Temp | Time | |
| Sandwich Loaf | 350° F./175° C. | 375° F./190° C. | 350° F./175° C. | 30-35 | min |
| Whole Grain Loaf | 350° F./175° C. | 425° F./218° C. | 375° F./190° C. | 30-40 | min |
| Dinner Rolls | 350° F./175° C. | 375° F./190° C. | 350° F./175° C. | 20-25 | min |
| Hamburger Buns | 350° F./175° C. | 400° F./205° C. | 400° F./205° C. | 15-25 | min |
| Hot dog Buns | 350° F./175° C. | 400° F./205° C. | 400° F./205° C. | 20 | min |
| Rustic No-Knead | 425° F./218° C. | 475° F./245° C. | *450° F./230° C. | 35-45 | min |
| Round | | | | | |
| Sourdough Round | 400° F./205° C. | 500° F./260° C. | **450° F./230° C. | 35-45 | min |
| Banana Bread | 325° F./162° C. | 350° F./175° C. | 350° F./175° C. | 60-65 | min |
| Zucchini Bread | 325° F./162° C. | 350° F./175° C. | 350° F./175° C. | 50-60 | min |
| Bagels | 400° F./205° C. | 475° F./245° C. | ***425° F./218° C. | 25 | min |
| French Loaf | 350° F./175° C. | 400° F./205° C. | 375° F./190° C. | 30-40 | min |
| Baguette | 375° F./190° C. | 500° F./260° C. | 450° F./230° C. | 30-35 | min |
| Pizza | 450° F./230° C. | 550° F./288° C. | 500° F./260° C. | 8-15 | min |
| Babka | 350° F./175° C. | 375° F./190° C. | 350° F./175° C. | 40-50 | min |
| Potato Bread Loaf | 350° F./175° C. | 375° F./190° C. | 350° F./175° C. | 35 | min |
| Milk Bread Loaf | 350° F./175° C. | 350° F./175° C. | 350° F./175° C. | 30-35 | min |
| Sweet Rolls | 350° F./175° C. | 375° F./190° C. | 350° F./175° C. | 20-25 | min |

In general, the incorporation of the low sodium salt composition of the present invention into bread doughs instead of traditional table salts (or other traditional salt crystals), may reduce baking times for any breads, including the bread types identified in the table above, by approximately 20% with one teaspoon of the low sodium salt being used per cup of flour in the dough preparation. In some embodiments, the low sodium salt may reduce baking times anywhere between 15% and 50%.

Below is a table demonstrating the exemplary amounts of energy cost savings for baking breads and other baked goods with the low sodium salt composition of the present invention as opposed to traditional table salt, for example, as a result of reduced proofing and/or bake times of the present invention:

| | | | | Cost to bake in US at |
|---|---|---|---|---|
| | | | | an exemplary rate of |
| | | | Cost to bake in US at | $0.22 kwh With low |
| | Bread Type & Energy | | an exemplary rate of | sodium salt |
| | Required to Bake | | $0.22 kwh | composition of |
| Baked Good | With Table Salt | | With Table Salt | present invention |
| White bread | 0.3-0.5 | kWh per loaf | $0.066-$0.11 | $0.05-$0.09 |
| Whole wheat | 0.4-0.6 | kWh per loaf | $0.088-$0.013 | $0.07-$0.01 |
| bread: | | | | |
| Sourdough bread | 0.5-0.7 | kWh per loaf | $0.11-$0.154 | $0.09-$0.12 |
| Rye bread | 0.6-0.8 | kWh per loaf | $0.132-$0.176 | $0.11-$0.14 |
| Pumpernickel | 0.8-1 | kWh per loaf | $0.176-$0.22 | $0.14-$0118 |
| bread | | | | |
| Sandwich Loaf | 0.3-0.4 | kWh per loaf | $0.066-$0.09 | $0.05-$0.07 |
| Whole Grain Loaf | 0.4-0.5 | kWh per loaf | $0.09-$0.11 | $0.072-$0.09 |
| Dinner Rolls | 0.2-0.3 | kWh per dozen | $0.04-$0.07 | $0.032-$0.056 |
| Hamburger Buns | 0.2-0.3 | kWh per dozen | $0.04-$0.07 | $0.032-$0.056 |
| Hot Dog Buns | 0.2-0.3 | kWh per dozen | $0.04-$0.07 | $0.032-$0.056 |
| Rustic No-Knead | 0.4-0.5 | kWh per loaf | $0.09-$0.11 | $0.072-$0.09 |
| Round | | | | |
| Sourdough Round | 0.5-0.6 | kWh per loaf | $0.11-$0.132 | $0.09-$0.105 |
| Banana Bread | 0.4-0.5 | kWh per loaf | $0.09-$0.11 | $0.072-$0.09 |
| Zucchini Bread | 0.4-0.5 | kWh per loaf | $0.09-$0.11 | $0.072-$0.09 |
| Bagels | 0.3-0.4 | kWh per dozen | $0.066-$0.09 | $0.052-$0.72 |
| French Loaf | 0.4-0.5 | kWh per loaf | $0.09-$0.11 | $0.072-$0.09 |
| Baguette | 0.5-0.6 | kWh per loaf | $0.11-$0.132 | $0.09-$0.105 |
| Pizza | 0.4-0.5 | kWh per pizza | $0.09-$0.11 | $0.072-$0.09 |
| Babka | 0.4-0.5 | kWh per loaf | $0.09-$0.11 | $0.072-$0.09 |
| Potato Bread Loaf | 0.4-0.5 | kWh per loaf | $0.09-$0.11 | $0.072-$0.09 |
| Milk Bread Loaf | 0.4-0.5 | kWh per loaf | $0.09-$0.11 | $0.072-$0.09 |

As demonstrated by the above table, the cost to bake the specified breads and other baked goods utilizing the low salt composition of the present invention is reduced by approximately 20%.

According to the U.S. Food and Drug Administration (FDA) and the World Health Organization, a healthy individual's recommended daily maximum consumption of sodium is 2300 milligrams (mg). Given this, the sodium content of bread using traditional recipes (e.g., incorporating traditional salts (e.g., table salts)) and manufacturing processes can account for a significant portion of a healthy individual's recommended daily maximum consumption of sodium. For example, the table below provides examples of sodium content for various types of breads:

| | Sodium |
|---|---|
| Bread Type | Content (mg) |
| White bread (2 slices) | 340 |
| Whole wheat bread (2 slices) | 276 |
| Rye bread (2 slices) | 422 |
| Multigrain bread (2 slices) | 253 |
| Sourdough bread (2 slices) | 304 |
| Mixed grain bread (2 slices) | 253 |
| Marble rye and pumpernickel bread (2 slices) | 346 |
| White and whole wheat swirl bread (2 slices) | 314 |
| Reduced calorie wheat bread (2 slices) | 235 |
| Reduced calorie white bread (2 slices) | 208 |
| Reduced calorie multigrain bread (2 slices) | 158 |
| Reduced calorie rye bread (2 slices) | 211 |
| Cracked wheat bread (2 slices) | 269 |
| Italian bread (2 slices) | 234 |
| Oatmeal bread (2 slices) | 323 |
| Raisin bread (2 slices) | 203 |
| Wheat bran bread (2 slices) | 350 |
| Dinner roll (1 roll) | 146 |
| Wheat dinner roll (1 roll) | 95 |
| Egg dinner roll (1 roll) | 191 |
| French roll (1 roll) | 231 |
| Hamburger or hotdog roll (1 roll) | 206 |
| Mixed grain hamburger or hotdog roll (1 roll) | 197 |
| White pita bread (1 pita) | 322 |
| Whole wheat pita bread (1 pita) | 340 |
| Plain bread stick (1 stick) | 66 |
| Cheese bread (2 slices) | 353 |
| Onion bread (2 slices) | 331 |
| Egg bread (2 slices) | 394 |
| Banana bread (2 slices) | 362 |
| Baguette (2 slices) | 780 |
| Ciabatta (2 slices) | 234 |

Therefore, an approximate 20% reduction in sodium content by utilizing the low sodium salt of the present invention in breads, including the bread types listed above, may reduce the percentage of daily sodium consumption for individuals.

In accordance with embodiments of the present invention, the low sodium salt composition may have a modified size and shape that affects the dissolution rate and distribution of the salt in the dough. For example, the low sodium salt composition may be in the form of a powder (e.g., powder-like) and may be configured to quickly dissolve and distribute into dough. In some examples, the powder form of the low sodium salt contributes to a faster dissolution and distribution rate of the salt, which may in turn contribute to shorter proofing or leaving times and quicker bake times.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of” In the present disclosure, any method or apparatus embodiment may be devoid of one or more process steps or components. In the present disclosure, embodiments employing negative limitations are expressly disclosed and considered a part of this disclosure.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A method of producing a low sodium dough, comprising the steps of:
combining a predetermined amount of flour, at least one leavening agent, and water with a low sodium salt composition, the low sodium salt composition being present at a ratio of one teaspoon of the low sodium salt composition per cup of flour, the low sodium salt composition comprising a plurality of salt particles of an average size of less than 30 microns adhered on a surface of a carrier particle; and
allowing the dough to undergo one or more proofing stages for a reduced amount of time as compared to standard proofing times for doughs formed with conventional table salts.

2. The method of claim 1, wherein the low sodium salt composition is formed by a process comprising:
providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and
exposing the aqueous salt-carrier slurry to a drying process to both: A) form a carrier particle comprised of the carrier medium; and B) form a plurality of salt particles of an average size of less than 100 nanometers on the surface of the carrier particle.

3. The method of claim 1, wherein the baked good is selected from a group consisting of breads, pastries, cakes, cookies, bagels, pitas, leavened confectionary snacks, and extruded leavened flavored snacks.

4. The method of claim 1, wherein a first proofing stage of the one or more proofing stages is reduced in time by at least 25% as compared to standard proofing times for doughs formed with conventional table salts and a second proofing stage of the one or more proofing stages is reduced in time by at least 36% as compared to standard proofing times for doughs formed with conventional table salts.

5. The method of claim 1, wherein the carrier particle is maltodextrin and the at least one leavening agent is yeast.

6. A method of reducing the leavening time and sodium content in a baked good, comprising the following steps:
preparing a dough comprising flour, at least one leavening agent, and water;
incorporating a salt-carrier composition comprising a plurality of micron-sized salt particles adhered to one or more carrier particles into the dough;
allowing the dough to undergo two proofing stages; and
baking the dough to form a baked good.

7. The method of claim 6, wherein the low sodium salt composition is formed by a process comprising:
providing an aqueous salt-carrier slurry comprising an aqueous solvent and a selected percent by weight of a solids mixture, wherein the solids mixture comprises a salt present in an amount between about 2.5% by weight and less than 14.9% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and
exposing the aqueous salt-carrier slurry to a drying process to both: A) form a carrier particle comprised of the carrier medium; and B) form a plurality of salt particles of an average size of less than 100 nanometers on the surface of the carrier particle.

8. The method of claim 6, wherein a first proofing stage of the two proofing stages is reduced in time by at least 25% when compared to standard proofing times for doughs comprising conventional table salts.

9. The method of claim 6, wherein a second proofing stage of the two proofing stages is reduced in time by at least 36% when compared to standard proofing times for doughs comprising conventional table salts.

10. The method of claim 6, wherein each particle of the salt-carrier composition has a particle size of less than 30-50 microns.

11. The method of claim 6, wherein each particle of the salt-carrier composition has a particle size of less than 100 nanometers.

12. The method of claim 6, wherein the carrier particles are maltodextrin particles and the salt-carrier composition comprises between 15-60% of the carrier particles by weight of the salt-carrier composition and 40-85% of the salt particles by weight of the salt-carrier composition.

13. The method of claim 6, wherein the carrier is tapioca and the at least one leavening agent is yeast.

14. The method of claim 6, wherein the baked good is selected from a group consisting of breads, pastries, cakes, bagels, pitas, leavened confectionary snacks, and extruded leavened flavored snacks.

15. A low sodium dough composition comprising:
a dough base comprising flour, at least one leavening agent, and water; and
a low sodium salt composition comprising a plurality of salt-particles of an average size of less than 50 microns to less than 30 microns adhered on a surface of one or more carrier particles.

16. The low sodium dough composition of claim 15, wherein the low sodium salt composition is formed by a process comprising:
providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and
exposing the aqueous salt-carrier slurry to a drying process to both: A) form a carrier particle comprised of the carrier medium; and B) form a plurality of salt particles of an average size of less than 100 nanometers on the surface of the carrier particle.

17. The low sodium dough composition of claim 15, wherein the low sodium dough is used to produce a baked good selected from a group consisting of breads, pastries, cakes, cookies, bagels, pitas, leavened confectionary snacks, and extruded leavened flavored snacks.

18. The low sodium dough composition of claim 15, wherein the carrier particle is maltodextrin and the at least one leavening agent is yeast.

19. The low sodium dough composition of claim 15, wherein the plurality of salt-particles are of an average size of less than 30 microns and the low sodium salt composition has a powder-like texture.

20. The low sodium dough composition of claim 15, wherein the plurality of salt-particles are of an average size of less than 100 nanometers.

21. The low sodium dough composition of claim 15, wherein the salt-carrier composition comprises between 15-60% of the carrier particles by weight of the salt-carrier composition and 40-85% of the salt particles by weight of the salt-carrier composition.
